(19) United States
(12) Patent Application Publication
(10) Pub. No.: US 2013/0037306 A1
(43) Pub. Date: Feb. 14, 2013

(54) MULTILAYER ELASTIC TUBE HAVING ELECTRIC PROPERTIES AND METHOD FOR MANUFACTURING THE SAME

(71) Applicant: SUN-KI KIM, Kyeonggi-do (KR)

(72) Inventor: SUN-KI KIM, Kyeonggi-do (KR)

(73) Assignees: JOINSET CO., LTD, Ansan-si (KR); SUN-KI KIM, Gunpo-si (KR)

(21) Appl. No.: 13/566,769

(22) Filed: Aug. 3, 2012

(30) Foreign Application Priority Data
Aug. 11, 2011 (KR) 10-2011-0080255
Sep. 9, 2011 (KR) 10-2011-0092181

(51) Int. Cl. H01B 5/06; B29C 65/48; B05D 5/12

(52) U.S. Cl. 174/126.1; 427/105; 156/60

(57) ABSTRACT

A multilayer elastic tube having electric property, the multilayer elastic tube including: an elastic core having a tube shape; and an elastic rubber coating layer adhering to an inner surface of the core, the elastic rubber coating layer having at least one electric property of electric conductivity, piezoelectricity, and electric wave absorptiveness. The elastic rubber coating layer is formed by curing liquid elastic rubber having the electric property and adhering to the inner surface of the core, and has a closed loop shape to improve the electric property.

### REFERENCE TO RELATED APPLICATIONS

This application claims the priority benefit of Korean Patent Application No. 10-201 1-0080255 filed on Aug. 11, 2011, and Korean Patent Application No. 10-201 1-00921 81 filed on Sep. 9, 2011, the entire contents of which are incorporated herein by reference.

### FIELD OF THE INVENTION

The present invention relates to a multilayer elastic tube, and more particularly, to a flexible multilayer elastic tube having reliable electric properties and configured to be easily manufactured with low manufacturing costs.

Furthermore, the present invention relates to a multilayer elastic tube which has an insulative and environmentally durable outer surface to prevent an electric short-circuit with an object when the elastic tube is actually applied, and is easily adapted for a change of environment and easily electrically connected to a conductive material inserted therein.

### BACKGROUND OF THE INVENTION

In the related art, cylindrical ferrite cores are used. Ferrite cores are manufactured by putting magnetic powder into a mold, pressing the powder, and performing a firing process. A signal wire or cable is inserted into a hole defined in such a ferrite core to remove electromagnetic wave noises generated from the signal wire or cable by the ferrite core.

However, ferrite cores are heavy, breakable due to less flexibility and elasticity, and need molds corresponding to sizes thereof. Also, disadvantageously, an injection molding process should be performed after a signal wire or cable is inserted into a hole of a ferrite core. Furthermore, a separate plastic case for fixing the signal wire or cable to the ferrite core is needed because it is difficult to accurately match an inner diameter of the hole with an outer diameter of the signal wire or cable.

According to another process for manufacturing an electric wire in the related art, a double extrusion process may be performed to continuously and simultaneously form a sheath of an insulation layer on an outer surface of a conductive core.

However, according to the related art described above, an adhesive force between a core and a sheath is poor, and it is difficult to thinly and uniformly form a core. Furthermore, it is difficult to extrude and precisely manufacture a core having electric properties due to high viscosity of the core. Also, since a sheath and a core having elasticity should be cured at a high temperature, it is difficult to extrude the sheath and core at the same time. It is difficult to allow such a core having elasticity, electric conductivity, and thin and uniform thickness to adhere to the inside of a tube shape made of an elastic sheath.

Korean Patent Application No. 2009-74277 filed by the inventor of the present invention discloses a multilayer elastic rubber component including: an elastic rubber core having a tube shape; a first elastic rubber coating layer adhering to and enclosing an outer surface of the core, the first elastic rubber coating layer having one electrical property; and a second elastic rubber coating layer adhering to and enclosing the first elastic rubber coating layer, the second elastic rubber coating layer having another electrical property, wherein the multilayer elastic rubber component has one of electric conductivity, piezoelectricity, electric wave absorptiveness, and a combination thereof.

However, according to the disclosed invention, since the elastic rubber coating layers having electric properties are stacked on the outer circumference surface of the elastic rubber core having a relatively large area, a large amount of liquid elastic rubber containing expensive powder having electric property may be used to increase manufacturing costs.

Also, since the elastic rubber coating layers having electric properties are stacked on the outer circumference surface of the elastic rubber core, it is difficult to use properties of the elastic rubber core itself due to the elastic rubber coating layers. That is, the elastic rubber core having an insulative property is more environmentally durable than the elastic rubber coating layers having electric properties. Thus, if the elastic rubber coating layers are exposed to the outside, the environmental durability of the elastic rubber component may be deteriorated.

Furthermore, if the elastic rubber coating layers having electric conductivity are disposed on the outer circumference surface of the elastic rubber core, the elastic rubber coating layers may be short-circuited with a conductive object adjacent to the elastic rubber coating layers.

Also, it is difficult to electrically connect the elastic rubber coating layers to a conductive material inserted to an elastic rubber tube.

### SUMMARY OF THE INVENTION

An object of the present invention is to provide a flexible multilayer elastic tube having reliable electric properties and configured to be easily manufactured with low manufacturing costs.

Another object of the present invention is to provide a multilayer elastic tube which has an insulative and environmentally durable outer surface to prevent the elastic tube from being electrically short-circuited with an object when the elastic tube is actually applied, and is easily adapted for a change of environment and easily electrically connected to a conductive material inserted therein.

A further another object of the present invention is to provide a multilayer elastic tube in which a conductive material is easily inserted into an elastic rubber coating layer, and a cutting portion is reliably and easily sealed.

According to an aspect of the present invention, there is provided a multilayer elastic tube having electric properties, the multilayer elastic tube including: an elastic core having a tube shape; and an elastic rubber coating layer adhering to an inner surface of the core, the elastic rubber coating layer having at least one electric property of electric conductivity, piezoelectricity, and electric wave absorptiveness, wherein the elastic rubber coating layer is formed by curing liquid elastic rubber having the electric property and adhering to the inner surface of the core, and has a closed loop shape to improve the electric property.

According to another aspect of the present invention, there is provided a multilayer elastic tube having electric properties, the multilayer elastic tube including: a tube-shaped elastic core having a cutting portion continuously extending in a length direction thereof; and an elastic rubber coating layer adhering to an inner surface of the core, the elastic rubber coating layer having at least one electric property of electric conductivity, piezoelectricity, and electric wave absorptiveness, wherein at least portions of mutually-facing cutting planes of the cutting portion are in contact with each other, and the elastic rubber coating layer is formed by curing liquid elastic rubber having the electric property and adhering to the inner surface of the core.

According to further another aspect of the present invention, there is provided a multilayer elastic tube having electric properties, the multilayer elastic tube including: a tube-shaped elastic core having a cutting portion continuously extending in a length direction thereof; and a flexible sheet adhering to an inner surface of the core with an elastic rubber coating layer therebetween, the flexible sheet having at least one electric property of electric conductivity, piezoelectricity, and electric wave absorptiveness, wherein at least a portion of mutually-facing cutting planes of the cutting portion is in contact with each other, and the elastic rubber coating layer is formed by curing liquid elastic rubber and adhering to the inner surface of the core.

According to further another aspect of the present invention, there is provided a method for manufacturing a multilayer elastic tube having electric properties, the method including: supplying an elastic tube continuously extending in a length direction; after vertically disposing the core, forcibly injecting liquid elastic rubber having an electric property into an end of a hole of the core in a state where the other end of the hole is opened; allowing the core to pass through rolls, thereby uniformly applying the liquid elastic rubber to an inner surface of the core; curing the liquid elastic rubber to form an elastic rubber coating layer having the electric property and adhering to the inner surface of the core; and cutting the core according to purposes.

According to further another aspect of the present invention, there is provided a method for manufacturing a multilayer elastic tube having electric properties, the method including: continuously cutting an elastic core in a length direction to form a cutting portion, and continuously supplying the elastic core having the cutting portion; while broadening the cutting portion of the elastic core, coating an inner surface of the core with liquid elastic rubber having an electric property; curing the liquid elastic rubber to form an elastic rubber coating layer having the electric property and adhering to the inner surface of the core; and cutting the core according to purposes.

Preferably, the core is one of rubber and thermoplastic polymer having elasticity.

Preferably, a protrusion protrudes inward from the inner surface of the core.

Preferably, a plurality of fins extend in a length direction of the core and radially protrude from an entire outer surface of the core.

Preferably, the liquid elastic rubber is prepared by mixing liquid silicone rubber with at least one of electric conductive powder, electric wave absorbing powder, and piezoelectric powder.

Preferably, the core is a heat shrinkable tube.

Preferably, the elastic rubber coating layer is also disposed on the cutting planes.

Preferably, at least a portion of the elastic rubber coating layer on the cutting portion is kept in electrical contact with each other to form a closed loop.

Preferably, the cutting portion is sealed with an elastic rubber adhesive.

Preferably, at least a portion of the cutting portion is kept in contact with each other by an elastic restoring force of the core.

Preferably, the cutting portion has a linear shape or a saw-toothed shape in the length direction.

Preferably, both ends of the core overlap each other at the cutting portion.

Preferably, the sheet is one of a metal film, a polymer film, a woven or knitted cloth, and a non-woven cloth which have at least one electric property of electric conductivity, piezoelectricity, and electric wave absorptiveness.

Preferably, the inner surface of the core is coated with the liquid elastic rubber while the core is moved upward.

Preferably, the method further comprises sealing the cutting portion using an elastic rubber adhesive to adhere.

### BRIEF DESCRIPTION OF THE DRAWINGS

The above objects and other advantages of the present invention will become more apparent by describing in detail exemplary embodiments thereof with reference to the attached drawings in which:

FIG. 1 is a perspective view of a multilayer elastic tube 100 according to an embodiment of the present invention;

FIG. 1A is a view illustrating an application example in the case where an elastic rubber coating layer has electric conductivity;

FIG. 2 is a perspective view of a multilayer elastic tube 200 according to another embodiment of the present invention;

FIG. 3 is a cross-sectional view of a multilayer elastic tube 300 according to another embodiment of the present invention;

FIG. 4 is a perspective view of a multilayer elastic tube 400 according to another embodiment of the present invention;

FIG. 5 is a perspective view of a multilayer elastic tube 500 according to another embodiment of the present invention; and

FIG. 6 is a perspective view of a multilayer elastic tube 600 according to another embodiment of the present invention.

### DETAILED DESCRIPTION OF THE INVENTION

Now, exemplary embodiments of the present invention will be described in detail with reference to the accompanying drawings.

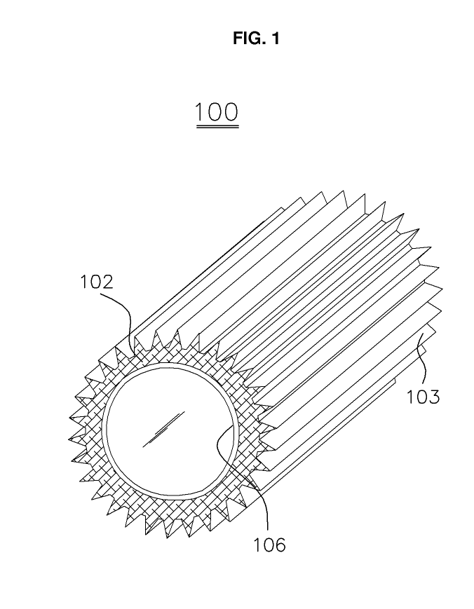

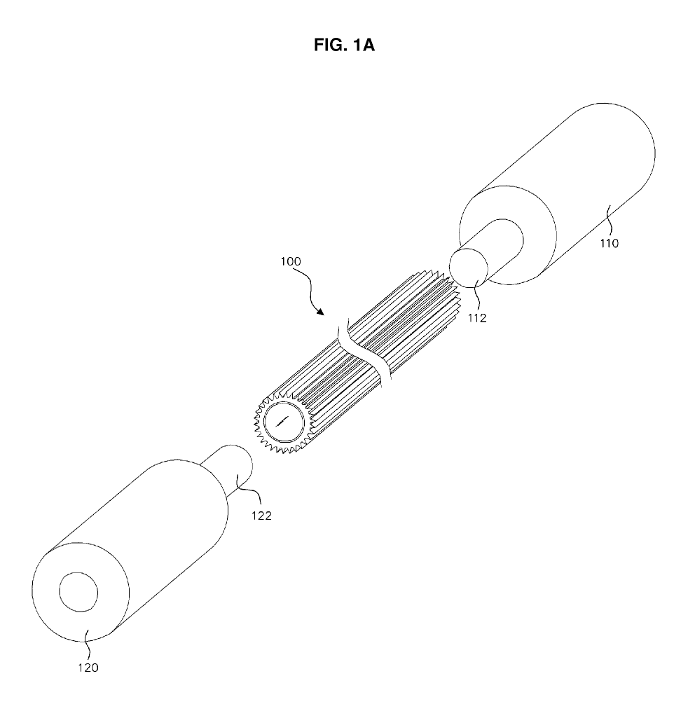

FIG. 1 is a perspective view of a multilayer elastic tube 100 according to an embodiment of the present invention.

Core (102)

A core 102 is formed of an elastic and having a tube shape.

The core 102 may be formed of one of rubber and thermoplastic polymer and be electrically insulative.

The core 102 may be a heat shrinkable tube.

Fins 103 extending along an outer surface of the core 102 in a length direction of the core 102 may radially protrude along a circumference of the core 102 so as to absorb an external impact. According to the above-described structure, the fins 103 may absorb a physical impact which is applied from the outside.

The core 102 may have a regular sectional shape.

Also, the outer surface of the core 102 may be coated with a protection layer to provide an elegant outer appearance or reduce a friction coefficient. Particularly, the outer surface of the core 102 may be coated with an environmentally durable protection layer. The protection layer may be formed of one of a flexible polymer resin, a polymer film, and a fiber.

Elastic Rubber Coating Layer (106)

An elastic rubber coating layer 106 is cured so as to adhere to an inner surface of the core 102. Also, the elastic rubber coating layer 106 may have one electric property of electric conductivity, piezoelectricity, and electric wave absorptiveness. Particularly, the elastic rubber coating layer 106 may have a closed loop shape to improve the electric property.

Liquid elastic rubber in which at least one of conductive powder, electric wave absorbing powder, and piezoelectric powder is mixed with liquid insulation elastic rubber may adhere to the inner surface of the core 102 by curing so as to form the elastic rubber coating layer 106.

The elastic rubber coating layer 106 disposed in the core 102 may have a substantially uniform thickness to provide reliable quality. That is, the elastic rubber coating layer 106 may have a uniform sectional shape.

When the elastic rubber coating layer 106 has electric conductivity, the elastic rubber coating layer 106 may protect a wire or cable within the core 102 against electromagnetic waves or be electrically grounded for the wire or cable. The elastic rubber coating layer 106 may have a volume electrical resistance of about 1 ohm or less. Here, the elastic rubber coating layer 106 may be manufactured by mixing conductive powder such as silver, nickel, carbon, gold, or copper with liquid silicone rubber. In this case, the content of the powder may be about 60% to about 88% by weight.

Also, when the elastic rubber coating layer 106 has electric wave absorptiveness, electricity transmitted through the cable received in the core 102 may be attenuated in electrical noise by the elastic rubber coating layer 106. For reference, the elastic rubber coating layer having electric wave absorptiveness may be formed of one of oxidized Mn—Zn-based or Ni—Zn-based materials or manufactured by mixing metal magnetic powder with liquid silicone rubber. In this case, the content of the powder may be about 60% to about 88% by weight.

Also, when the elastic rubber coating layer 106 piezoelectricity, a piezoelectric tube which provides piezoelectric properties to a conductive material received in the core 102 may be used as the elastic rubber coating layer 106.

The multilayer elastic tube may have one of an electric line function, an electric wave absorbing function, and a piezoelectric function, and a combination thereof.

Also, the multilayer elastic tube 100 manufactured as described above may have various electric properties and be used for various mechanical purposes owing to a closed-loop tube shape formed by the tube-shaped core 102 and the elastic rubber coating layer 106.

The elastic rubber coating layer 106 may integrally adhere to the inside of the core 102.

The core 102 may be formed of the same organic material as that of the elastic rubber coating layer 106. Furthermore, each of the core 102 and the elastic rubber coating layer 106 may be formed of silicone rubber.

FIG. 1A is a view illustrating an application example for the case where the elastic rubber coating layer 106 has electric conductivity.

The elastic tube 100 may be used for connecting cables 110 and 120 used in a robot arm or an elevator. That is, since the elastic rubber coating layer 106 disposed within the core 102 of the elastic tube 100 has electric conductivity, when core wires 112 and 122 of the cables 110 and 120 are respectively inserted into both ends of the elastic tube 100 to fix the core wires 112 and 122 to the elastic tube 100 through a fixing unit, electricity is conducted between the core wires 112 and 122 through the elastic rubber coating layer 106. According to the above-described structure, the core wires 112 and 122 having relatively poor flexibility and bending properties can be electrically connected through the elastic rubber coating layer 106 while being flexible and bendable due to the physical properties of the core 102.

Hereinafter, a method for manufacturing the elastic tube 100 of the embodiment will be described.

First, rubber gum is extruded through dies a rubber extruder having a predetermined shape and is thermally cured, thereby continuously manufacturing a tube-shaped elastic rubber core 102 in the form of a roll.

Then, the rolled core 102 is vertically disposed, and in a state where an end of a hole formed in the core 102 is opened, liquid elastic rubber having an electric property is injected into the other end of the hole of the core 102.

Here, since the core 102 is vertically disposed, the core 102 may be uniformly coated with the liquid elastic rubber by gravity. Also, as described above, the liquid elastic rubber having an electric property may be a liquid elastic rubber adhesive in which at least one of conductive powder, electric wave absorbing powder, and piezoelectric powder is mixed with liquid insulation elastic rubber.

Thereafter, when the core 102 passes between rolls, the inner surface of the rolled core 102 is uniformly coated with the liquid elastic rubber. In this state, the liquid elastic rubber is cured by heat so as to form an elastic rubber coating layer 106 adhering to the inside of the core 102. Here, since the core 102 itself is elastic, the core may be restored in an original shape thereof even though the core 102 is pressed by the rolls.

As a result, a closed loop may be formed in the core 102 by the elastic rubber coating layer 106 having an electric property.

Then, the rolled elastic tube having an electric property is cut into predetermined lengths using a knife according to purposes. In this way, an elastic tube having electric properties can be manufactured according to the present invention.

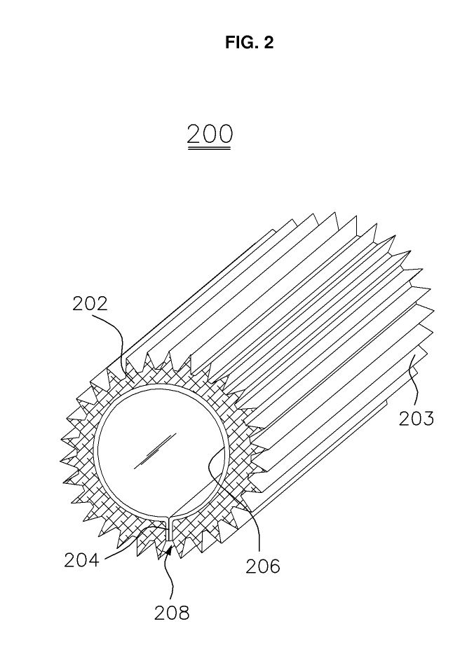

FIG. 2 is a perspective view of a multilayer elastic tube 200 according to another embodiment of the present invention.

According to the current embodiment, a core 202 may be formed of a tube-shaped elastic having a cutting portion 208 continuously defined in a length direction of the core 202.

In the cutting portion 208 of the core 202, at least portions of both cutting planes 204 of the core 202 may be kept in contact with each other by an elastic restoring force of the core 202 itself. Thus, the cutting portion 208 having elasticity may be broadened to easily insert a cable into the core 202. Also, both surfaces of the cutting portion 208 may be easily maintained in contact with each other to prevent the cable from being easily separated.

As described above, the cutting portion 208 is defined along a length direction of the core 202. Also, the cutting portion 208 may have a linear shape or a saw-toothed shape.

An elastic rubber coating layer 206 may be formed through the cutting portion 208. According to the above-described structure, when compared to the foregoing embodiment, the current embodiment may be adequately applied to the case where it is difficult to inject liquid elastic rubber due to a small diameter of the core 202 or due to high viscosity of the liquid elastic rubber.

Fins 203 extending in a length direction of the core 202 may radially protrude from the entire outer surface of the core 202. According to this structure, when the cutting portion 208 between the fins 203 is sealed using an elastic rubber adhesive, a receiving space for receiving the elastic rubber adhesive may be naturally defined by the fins 203 adjacent to each other to improve workability and hide the elastic rubber adhesive for a fine view.

The cutting planes 204 formed along the cutting portion 208 may adhere to each other by curing the liquid elastic rubber adhesive to seal the inside of the core 202.

In this case, the elastic tube 200 may be used for the same purposes as the elastic tube 100 of FIG. 1.

Also, the cutting portion 208 may be used for forming the elastic rubber coating layer 206 on an inner surface of the core 202 in addition to the use for taking the cable in or out of the core 202 through the cutting portion 208.

That is, in the multilayer elastic tube 200 according to the current embodiment, the cable may be taken in or out of the core 202 through the cutting portion 208 of the core 202. However, when the cutting portion 208 is sealed by the elastic rubber adhesive, the cable may be taken in or out of the core 202 through both cutting planes of the elastic tube 200.

Also, the outer surface of the core 202 may be coated with a protection layer to provide an elegant outer appearance or reduce a friction coefficient. The protection layer may be formed of one of a polymer film and a fiber.

The elastic rubber coating layer 206 adheres to the inner surface of the core 202. Also, the elastic rubber coating layer 206 may have one electric property of electric conductivity, piezoelectricity, and electric wave absorptiveness. Here, as shown in FIG. 2, the elastic rubber coating layer 206 may be provided on the cutting planes 204 of the cutting portion 208.

When the elastic rubber coating layer 206 is also disposed on the cutting planes 204, the elastic rubber coating layer 206 may form an electrically closed loop to improve the electric property.

The elastic rubber coating layer 206 is formed by performing a dipping process on the inner surface of the core 202 through the cutting portion 208 to coat the inner surface of the core 202.

Hereinafter, a method for manufacturing the elastic tube 200 of the other embodiment will be described.

First, rubber gum is extruded through dies of an extruder having a predetermined shape and is cured, thereby continuously manufacturing a tube-shaped elastic rubber core 202. Then, the core 202 is cut so that the core 202 has a continuous cutting portion 208 in a length direction thereof. Thereafter, the core 202 is thermally cured. However, the present invention is not limited thereto. For example, the cutting portion 208 may be formed using a dies mold.

Cutting planes 204 formed along the cutting portion 208 of the core 202 may face each other, contact each other, or be overlapped with each other at portions adjacent to the cutting planes 204.

Thereafter, the cutting portion 208 of the core 202 is vertically positioned and is broadened to coat an inner surface of the core 202 with liquid elastic rubber. Here, an outer surface of the core 202 is not coated with the liquid elastic rubber.

The inner surface of the core 202 may be coated with the liquid elastic rubber while being moved upward. In this case, the inner surface of the core 202 may be uniformly and thinly coated with the liquid elastic rubber by gravity. However, the present invention is not limited thereto. For example, the inner surface of the core 202 may be coated while being moved upward in a state where the core 202 is inclined at a predetermined angle according to the shape or kind of the core 202.

Also, the inner surface of the core 202 may be continuously and repeatedly coated with the liquid elastic rubber and then cured until the core 202 has desired electric properties. That is, the inner surface of the core 202 may be continuously and repeatedly coated with the liquid elastic rubber to a desired coating thickness.

Thereafter, the liquid elastic rubber is cured so as to adhere to the inner surface and/or the cutting planes 204 of the core 202.

The liquid elastic rubber, which is coated on the inner surface of the core 202 and has the electric property, is cured to form an elastic rubber coating layer 206 having the electric property.

Here, since the core 202 itself is an elastic, the core 202 may be restored in an original shape thereof even though the core 202 is pressed by rolls. In addition, the elastic rubber coating layer 206 may be adjusted in thickness by passing through the rolls.

Then, the rolled elastic tube having the electric property is cut into predetermined lengths using a knife according to purposes. In this way, the elastic tube having the electric property may be manufactured according to the present invention.

Thereafter, the cutting portion 208 may be reliably sealed using an elastic rubber adhesive so that the cutting planes of the cutting portion 208 can adhere to each other.

Here, the elastic rubber adhesive is formed by curing the liquid elastic rubber adhesive. The elastic rubber adhesive may be a silicone rubber adhesive.

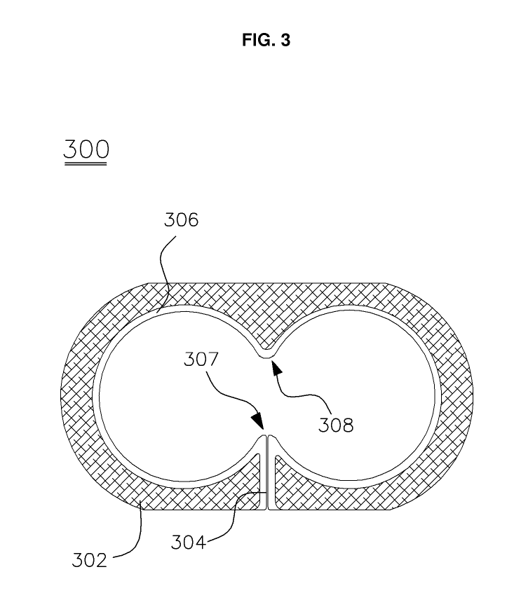

FIG. 3 is a cross-sectional view of a multilayer elastic tube 300 according to another embodiment of the present invention.

According to the current embodiment, the inside of a core 302 may have a dumbbell shape in section. Thus, protrusions 307 and 308 are disposed on top and bottom surfaces of the inside of the core 302, respectively.

According to this structure, a cable inserted into the core 302 may be pressed and fixed by the protrusions 307 and 308, which are respectively disposed on the top and bottom surfaces of the inside of the core 302.

Unlike this embodiment, the protrusions 307 and 308 may be disposed on portions different from the top and bottom surfaces of the inside of the core 302.

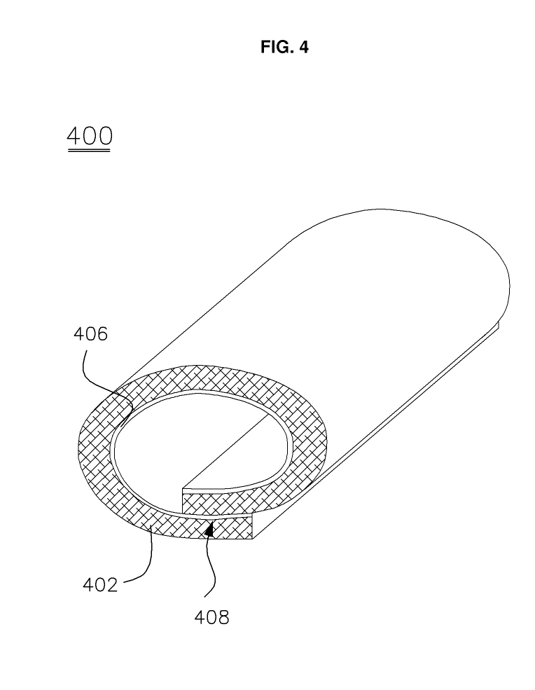

FIG. 4 is a perspective view of a multilayer elastic tube 400 according to another embodiment of the present invention.

According to the current embodiment, both ends of a cutting portion 408 of a core 402 may overlap each other. Also, the overlapping portions may adhere to each other by, for example, an elastic rubber adhesive.

In the above embodiments, since the elastic rubber adhesive is applied to a relatively small contact area, a large adhesion force may not be obtained. However, according to the current embodiment, a larger adhesion force may be obtained because the overlapping portions are large in area.

This structure may be easily applied when the elastic tube 400 is relatively large.

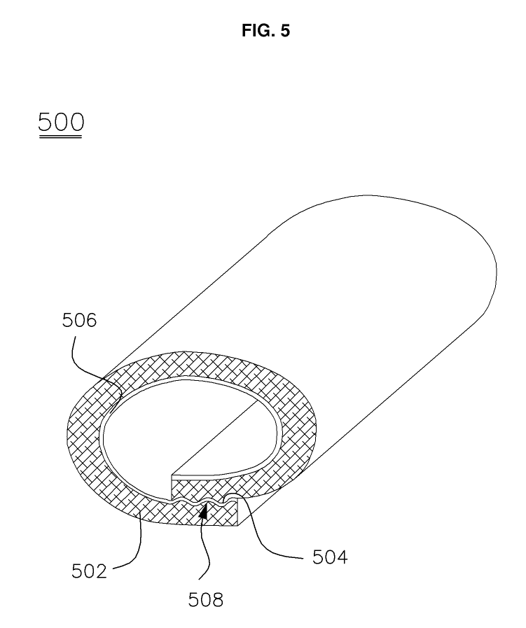

FIG. 5 is a perspective view of a multilayer elastic tube 500 according to another embodiment of the present invention.

When compared to the embodiment of FIG. 4, a roughness 504 is provided on each of overlapping portions 508 to mechanically couple the overlapping portions 508 to each other through the roughness 504. Particularly, if an elastic rubber adhesive is additionally used, the overlapping portions 508 may easily adhere to each other, and an adhesion force therebetween may be improved to ensure reliable waterproofing.

This structure may be easily applied when the elastic tube 500 is relatively large.

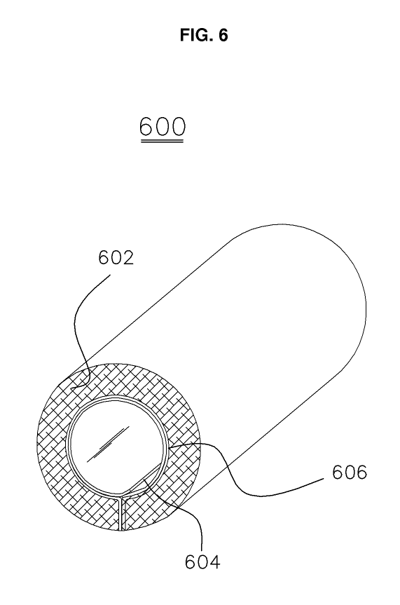

FIG. 6 is a perspective view of a multilayer elastic tube 600 according to another embodiment of the present invention.

According to the current embodiment, an elastic rubber coating layer 606 is disposed on an inner surface of a core 602, and then a flexible sheet 604 adheres to the elastic rubber coating layer 606.

The sheet 604 has one electric property of electric conductivity, piezoelectricity, and electric wave absorptiveness.

The sheet 604 may be one of a metal film, a polymer film, a woven or knitted cloth, and a non-woven cloth which have one electric property of electric conductivity, piezoelectricity, and electric wave absorptiveness.

Typically, when the sheet 604 is used, although the elastic rubber coating layer 606 according to the current embodiment has lower flexibility and elasticity than the elastic rubber coating layer 106 of FIG. 1, the elastic tube 600 may be easily manufactured, have uniform quality, and be relatively inexpensive.

The elastic rubber coating layer 606 may be electrically insulated and also manufactured by curing liquid elastic rubber coating layer.

The coating layer 606 and the sheet 604, which are supplied through a cutting portion, may adhere to each other by curing the liquid elastic rubber coating layer 606.

According to the above-described embodiments, since the elastic rubber coating layer having the electric property is stacked and adheres to the inner surface of the elastic rubber core, a relatively small amount of liquid elastic rubber may be used when compared to the case in which the liquid elastic rubber containing expensive powder having electric property is disposed on the outside of the core, thereby reducing manufacturing costs.

Also, since the elastic rubber coating layer having the electric property is stacked and adheres through the cutting portion continuously defined in a length direction of the core, the coating layer may have a reliably uniform thickness and superior electric property and be easily manufactured.

Also, since the elastic rubber coating layer having the electric property is stacked and adheres to the inner surface of the elastic rubber core, environmental durability can be improved, and an electrical short-circuit with an external object may be prevented.

Also, since the elastic rubber coating layer having the electric property is disposed within the elastic rubber core, the conductive material inserted into the elastic rubber core may be easily electrically connected.

Also, the conductive material may be easily inserted into the elastic rubber coating layer through the cutting portion, and the cutting portion may be reliably sealed using the elastic rubber adhesive.

While the present invention has been described in detail, it should be understood that various changes, substitutions and alterations can be made hereto without departing from the spirit and scope of the invention as defined by the appended claims.

What is claimed is:

1. A multilayer elastic tube having electric properties, the multilayer elastic tube comprising:
an elastic core having a tube shape; and
an elastic rubber coating layer adhering to an inner surface of the core, the elastic rubber coating layer having at least one electric property of electric conductivity, piezoelectricity, and electric wave absorptiveness,
wherein the elastic rubber coating layer is formed by curing liquid elastic rubber having the electric property and adhering to the inner surface of the core, and has a closed loop shape to improve the electric property.

2. The multilayer elastic tube of claim 1, wherein the core is one of rubber and thermoplastic polymer having elasticity.

3. The multilayer elastic tube of claim 1, wherein a protrusion protrudes inward from the inner surface of the core.

4. The multilayer elastic tube of claim 1, wherein a plurality of fins extend in a length direction of the core and radially protrude from an entire outer surface of the core.

5. The multilayer elastic tube of claim 1, wherein the liquid elastic rubber is prepared by mixing liquid silicone rubber with at least one of electric conductive powder, electric wave absorbing powder, and piezoelectric powder.

6. The multilayer elastic tube of claim 1, wherein the core is a heat shrinkable tube.

7. A multilayer elastic tube having electric properties, the multilayer elastic tube comprising:
a tube-shaped elastic core having a cutting portion continuously extending in a length direction thereof; and
an elastic rubber coating layer adhering to an inner surface of the core, the elastic rubber coating layer having at least one electric property of electric conductivity, piezoelectricity, and electric wave absorptiveness,
wherein at least portions of mutually-facing cutting planes of the cutting portion are in contact with each other, and the elastic rubber coating layer is formed by curing liquid elastic rubber having the electric property and adhering to the inner surface of the core.

8. The multilayer elastic tube of claim 7, wherein the elastic rubber coating layer is also disposed on the cutting planes.

9. The multilayer elastic tube of claim 7, wherein at least a portion of the elastic rubber coating layer on the cutting portion is kept in electrical contact with each other to form a closed loop.

10. The multilayer elastic tube of claim 7, wherein the cutting portion is sealed with an elastic rubber adhesive.

11. The multilayer elastic tube of claim 7, wherein at least a portion of the cutting portion is kept in contact with each other by an elastic restoring force of the core.

12. The multilayer elastic tube of claim 7, wherein the cutting portion has a linear shape or a saw-toothed shape in the length direction.

13. The multilayer elastic tube of claim 7, wherein both ends of the core overlap each other at the cutting portion.

14. A multilayer elastic tube having electric properties, the multilayer elastic tube comprising:
a tube-shaped elastic core having a cutting portion continuously extending in a length direction thereof; and
a flexible sheet adhering to an inner surface of the core with an elastic rubber coating layer therebetween, the flexible sheet having at least one electric property of electric conductivity, piezoelectricity, and electric wave absorptiveness,
wherein at least a portion of mutually-facing cutting planes of the cutting portion is in contact with each other, and the elastic rubber coating layer is formed by curing liquid elastic rubber and adhering to the inner surface of the core.

15. The multilayer elastic tube of claim 14, wherein the sheet is one of a metal film, a polymer film, a woven or knitted cloth, and a non-woven cloth which have at least one electric property of electric conductivity, piezoelectricity, and electric wave absorptiveness.

16. A method for manufacturing a multilayer elastic tube having electric properties, the method comprising:
supplying an elastic tube continuously extending in a length direction;
after vertically disposing the core, forcibly injecting liquid elastic rubber having an electric property into an end of a hole of the core in a state where the other end of the hole is opened;
allowing the core to pass through rolls, thereby uniformly applying the liquid elastic rubber to an inner surface of the core;
curing the liquid elastic rubber to form an elastic rubber coating layer having the electric property and adhering to the inner surface of the core; and
cutting the core according to purposes.

17. A method for manufacturing a multilayer elastic tube having electric properties, the method comprising:
continuously cutting an elastic core in a length direction to form a cutting portion, and continuously supplying the elastic core having the cutting portion;
while broadening the cutting portion of the elastic core, coating an inner surface of the core with liquid elastic rubber having an electric property;
curing the liquid elastic rubber to form an elastic rubber coating layer having the electric property and adhering to the inner surface of the core; and
cutting the core according to purposes.

18. The method of claim 17, wherein the inner surface of the core is coated with the liquid elastic rubber while the core is moved upward.

19. The method of claim 17, further comprising sealing the cutting portion using an elastic rubber adhesive to adhere.
